(19) United States
(12) Patent Application Publication
(10) Pub. No.: US 2013/0118080 A1
(43) Pub. Date: May 16, 2013

(54) DOOR AND DOOR FRAME ASSEMBLY

(71) Applicants: Klaus Fink, Hinckley, OH (US); Michael Braun, Fort Wayne, IN (US)

(72) Inventors: Klaus Fink, Hinckley, OH (US); Michael Braun, Fort Wayne, IN (US)

(73) Assignee: THERMA-TRU CORPORATION, Maumee, OH (US)

(21) Appl. No.: 13/722,289

(22) Filed: Dec. 20, 2012

Related U.S. Application Data
(62) Division of application No. 12/031,790, filed on Feb. 15, 2008, now abandoned.
(60) Provisional application No. 60/901,731, filed on Feb. 16, 2007.

(51) Int. Cl. E05F 15/20; E05B 61/00; E05F 15/00; E05B 65/06

(52) U.S. Cl. CPC E05F 15/20; E05B 65/06; E05B 61/00; E05F 15/00
USPC 49/31; 49/394; 49/363; 49/386; 49/324

(57) ABSTRACT

Door and frame assemblies are disclosed by the present application. In one exemplary embodiment, the a door is connected to a door frame, such that the door is moveable between an open position and a closed position. Activation of a trigger causes a door frame coupling arrangement to couple the door frame to the door in a closed position to thereby inhibit movement of the door relative to the frame. In another exemplary embodiment, a door is coupled to a door frame by a hinge. The hinge is configured to move the door in translation as the door is rotated from the open position to the closed position. For example, the hinge may move the door downward, toward the sill, when the door is moved from the open position to the closed position.

### RELATED APPLICATIONS

The present application claims the benefit of U.S. Provisional Patent Application Ser. No. 60/901,731, filed on Feb. 16, 2007, titled “Door and Door Frame Assembly.” U.S. Provisional Patent Application Ser. No. 60/901,731 is incorporated herein by reference in its entirety.

### BACKGROUND OF THE INVENTION

Door latch assemblies for use with hinged doors are well known in the art. Door latch assemblies typically include one or more movable latch members mounted along a free side edge of the door. The moveable latch member cooperates with a strike mounted to a door jamb to selectively latch and unlatch the door frame with the door jamb. A door handle, lever or knob is typically used with the latch assembly. The door handle, lever, or knob allows the latch member to be manually withdrawn from the strike plate to allow the door to be opened. A deadbolt is frequently associated with the latch member for locking the door and the door jamb together.

### SUMMARY

The present application discloses a variety of different exemplary embodiments of door and door frame assemblies. In one exemplary embodiment, a door is connected to a door frame, such that the door is moveable between an open position and a closed position. Activation of a trigger causes a door frame coupling arrangement to couple the door frame to the door in a closed position to thereby inhibit movement of the door relative to the frame.

In another exemplary embodiment, a door is coupled to a door frame by a hinge. The hinge is configured to move the door in translation as the door is rotated from the open position to the closed position. For example, the hinge may move the door downward, toward the sill, when the door is moved from the open position to the closed position.

### BRIEF DESCRIPTION OF THE DRAWINGS

FIG. 1 is a perspective view of a door and a door frame assembly;

FIG. 2A is a rear view of a door and door frame assembly;

FIG. 2B is a rear view of a door and door frame assembly, where a sill of the door frame includes a door coupling arrangement;

FIG. 2C is a rear view of a door and door frame assembly, where a sill of the door frame and a top of the door frame each include a door coupling arrangement;

FIG. 2D is a rear view of a door and door frame assembly, where a sill of the door frame, a latch side of the door frame, and a top of the door frame each include a door coupling arrangement;

FIG. 2E is a rear view of a door and door frame assembly, where a sill of the door frame, a latch side of the door frame, a hinge side of the door frame, and a top of the door frame each include a door coupling arrangement;

FIG. 3 is a schematic illustration of a door frame coupling arrangement that engages a side of a door;

FIG. 4 is a schematic illustration of a door frame coupling arrangement that engages an edge of a door;

FIG. 5 is a schematic illustration of a door frame coupling arrangement that engages a face of a door;

FIG. 6 is a schematic illustration of a door frame coupling arrangement that engages two edges of a door;

FIG. 7 is a schematic illustration of a door frame coupling arrangement that engages both faces of a door;

FIG. 8A is a schematic illustration of a door frame coupling arrangement that engages a recess in a side of a door;

FIG. 8B is a view taken along lines 8B-8B of FIG. 8A;

FIG. 9A is a schematic illustration of a door frame coupling arrangement that includes pins that engage bores in a side of a door;

FIG. 9B is a view taken along lines 9B-9B of FIG. 9A;

FIG. 10 is a schematic illustration of a door frame and coupling arrangement that comprises a magnet;

FIG. 11 is a schematic illustration of a door frame and coupling arrangement that comprises a magnet;

FIG. 12A is a rear view of a door;

FIG. 12B is a hinge side view of a door;

FIG. 12C is a latch side view of a door;

FIG. 12D is a bottom side view of a door;

FIG. 13 is a rear view of a door frame;

FIG. 14 is a schematic illustration of a spring actuated coupling arrangement;

FIG. 15A is a schematic illustration of a lever actuated coupling arrangement in a deactivated condition;

FIG. 15B is a schematic illustration of the lever actuated coupling arrangement in an activated condition;

FIG. 16A is a schematic illustration of a coupling arrangement that includes a coupling member that is guided by a slide member, with the coupling member in a retracted position;

FIG. 16B is a schematic illustration of the coupling arrangement of FIG. 16A with the coupling member in an extended position;

FIG. 17 is a schematic illustration of a coupling arrangement that includes a powered actuator;

FIG. 18A is a schematic illustration of a manual coupling arrangement in a disengaged position;

FIG. 18B shows the coupling arrangement of FIG. 18A in an engaged position;

FIG. 19 is a schematic illustration of a coupling arrangement that includes a rack and pinion mechanism;

FIG. 20A is a schematic illustration of a door spaced apart from a sill;

FIG. 20B illustrates the door and sill of FIG. 20, where the door is moving closer to the sill;

FIG. 21A is a top view of a door hinge;

FIG. 21B is a view taken along lines 21B-21B in FIG. 21A;

FIG. 22A it is a view of the door hinge of FIG. 21A with a leaf of the hinge rotated to a second position;

FIG. 22B is a view taken along lines 22B-22B in FIG. 22A;

FIG. 23A is a bottom view of a door hinge coupled to a door frame;

FIG. 23B is a view taken along lines 23B-23B in FIG. 23A;

FIG. 24A shows the door hinge and frame of FIG. 23A moved to a partially closed position;

FIG. 24B is a view similar to the view of FIG. 23B showing that movement of the door hinge to a the partially closed position moves the hinge downward with respect to the door frame;

FIG. 25A is a schematic illustration of a door and a door frame that includes a jamb stop;

FIG. 25B shows the door and door frame of FIG. 25A where the door has moved closer to the jamb stop;

FIG. 26A is a bottom view of a door hinge coupled to a door frame;

FIG. 26B is a view taken along lines 26B-26B in FIG. 26A;

FIG. 27A shows the door hinge and frame of FIG. 26A moved to a partially closed position;

FIG. 27B is a view similar to the view of FIG. 26B showing that movement of the door hinge to the partially closed position moves the hinge toward the door frame;

FIG. 28A is a bottom view of a door hinge coupled to a door frame;

FIG. 28B is a view taken along lines 28B-28B in FIG. 28A;

FIG. 29A shows the door hinge and frame of FIG. 28A moved to a partially closed position; and

FIG. 29B is a view similar to the view of FIG. 28B showing that movement of the door hinge to the partially closed position moves the hinge toward the door frame and downward.

### DETAILED DESCRIPTION

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, hardware, and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

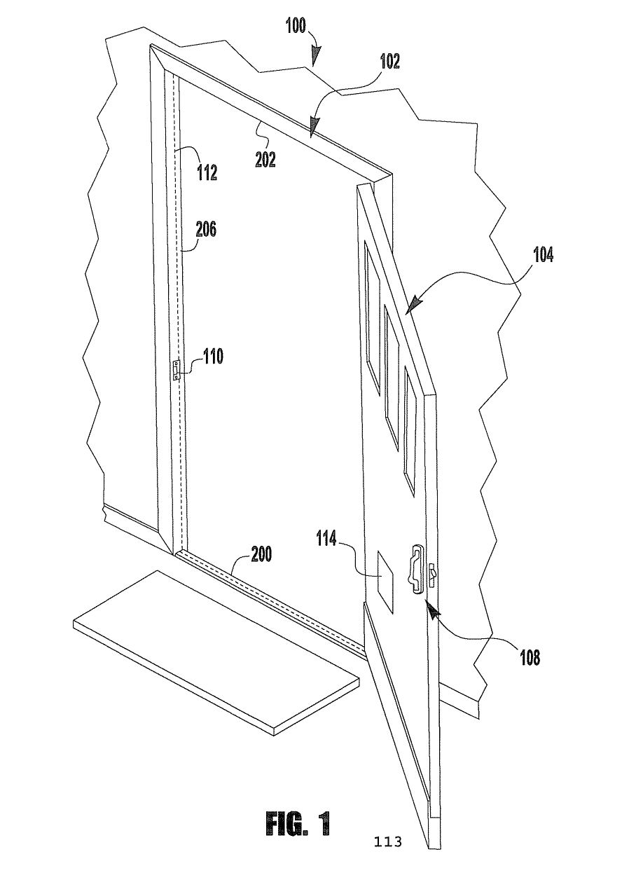

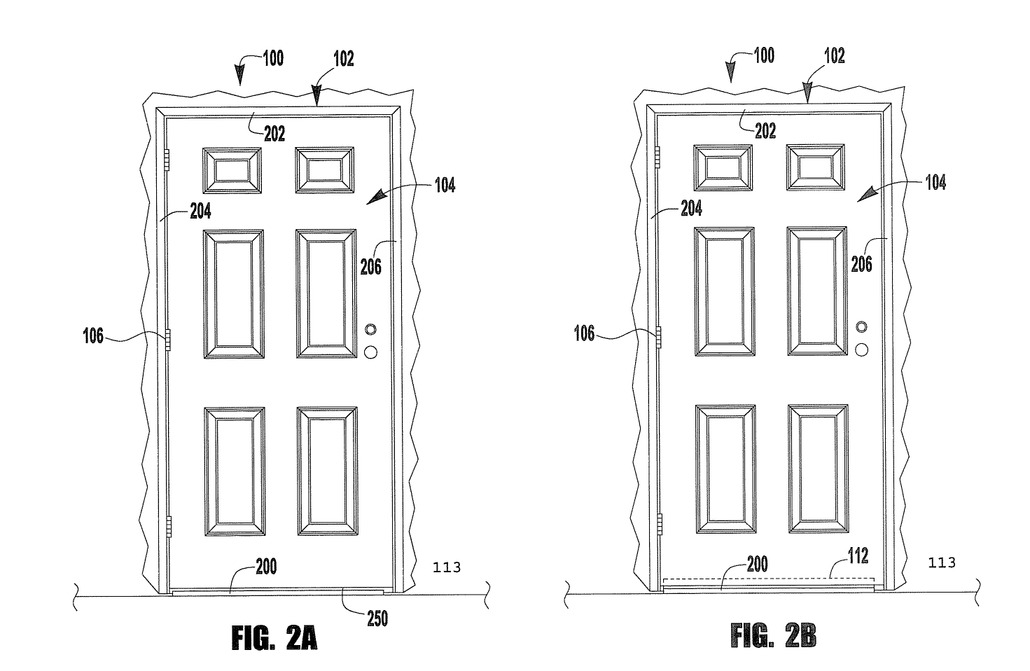

The present application discloses door and door frame assemblies 100 that include a door frame 102 and a door 104 that is connected to the frame, such that the door is moveable between an open position (see FIG. 1) and a closed position (see FIG. 2A). Note that the hinges of the door shown in FIG. 1 are on the right side of the door and the hinges of the doors shown in FIGS. 2A-2E are on the left side of the door. The door may take a wide variety of different forms. In one embodiment, the door is a residential building door, such as an entrance door of a house. The door 104 may be connected to the door frame in a wide variety of different ways. For example, the door 104 may be connected to the frame 102 with hinges 106 (See FIG. 2A). The door may include a latch arrangement 108 (FIG. 1) that cooperates with a strike 110 mounted to the door frame 102 to selectively latch the door 104 in the closed position or allow the door to be opened. A wide variety of latch arrangements are known. For example, the latch arrangement 108 may be a door knob and/or a deadbolt. In one embodiment, the door frame 102 includes a coupling arrangement 112 and a trigger 114 in communication with the door frame coupling arrangement (illustrated schematically in FIG. 1) in addition to the latch arrangement 108. Activation of the trigger causes the coupling arrangement 112 of the door frame 102 to couple the door frame to the door 104 in the closed position and thereby inhibit movement of the door to the open position. In the exemplary embodiment, when the door and the door frame are coupled by the coupling arrangement, the door is inhibited from moving significantly from the closed position, without decoupling the door frame from the door. Often, when a door 104 that is latched in the closed position by the latch arrangement 108 is subjected to high winds, the door may deflect. The deflection may cause a corner portion 113 (See FIGS. 2A and 2B) of the door 104 to move away from the frame 102 even though the door is latched in the closed position by the latch arrangement 108. This movement of the door corner 113 may create a gap between the door 104 and the door frame 102, through which water, air, or light could pass. In one embodiment, substantially all portions of the door are prevented from moving significantly from the closed position when the coupling arrangement 112 couples the door 104 to the door frame 102. The coupling arrangement 112 may be configured to prevent a corner portion 113 of the door 114 from moving relative to the frame when the door is in the closed position. In one embodiment, the coupling arrangement is configured to act as a barrier that inhibits or prevents water, air and/or light from passing between the door 104 and the door frame 102, at least at the interface between the coupling arrangement 112 and the door 104. The coupling arrangement 112 may include any feature, any combination or any subcombination of the coupling arrangement features described in this application.

In an exemplary embodiment, the door 104 includes an active member of the latch arrangement 108 that selectively engages a stationary member of the door frame, such as the strike 110 and the door frame 102 includes an active member of the coupling arrangement 112. In this application, an active member is a member that moves or applies a force to couple the active member with another member.

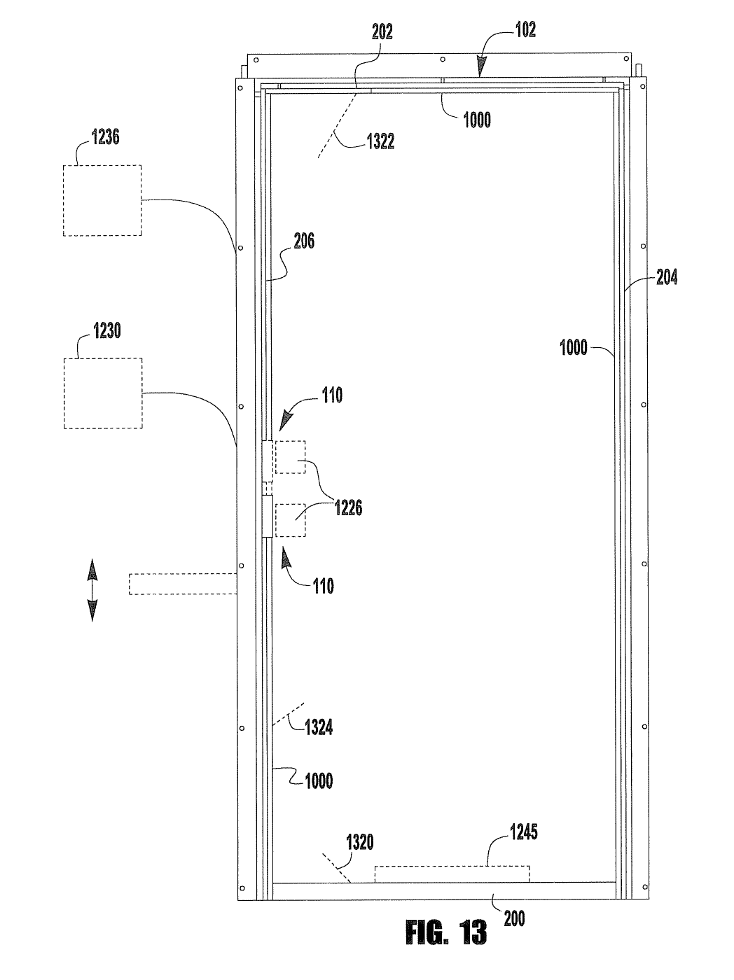

Referring to FIG. 2A, the door frame 102 may include a sill 200, a top side 202, a hinge side 204, and a latch side 206. Any one or more of the door frame sides may include a jamb stop 1000 (see FIG. 13). The jamb stop 1000 defines the position of the door 104 in the closed position. Typically, the top side 202, hinge side 204, and latch side 206 include jamb stops. The door frame 102 may also include additional accessories. For example, the door frame 102 may include a trim piece, such as a brick molding, that hides the interface between a wall and the door frame, a frame extending component, such as a screen door adapter or track, or a sill extending component, such as a sill extender that attaches to the sill to cover a larger rough frame member. One or more of the door frame sides 200, 202, 204, 206 may include a coupling arrangement 112. Further, one or more of the door jamb stops 1000 and/or a door frame accessory may include a coupling arrangement 112 in addition to the door frame sides 200, 202, 204, 206 or instead of the door frame sides. The coupling arrangement 112 can be included in any one or more of the door frame components. FIG. 2B schematically illustrates a sill 200 that includes a coupling arrangement. FIG. 2C schematically illustrates a door frame 102 where the sill 200 and the top side 202 each include a coupling arrangement. FIG. 2D schematically illustrates a door frame 102 where the sill 200, the top side 202 and the latch side 206 each include a coupling arrangement. FIG. 2E schematically illustrates a door frame 102 where the sill 200, the top side 202, the hinge side 204, and the latch side 206 each include a coupling arrangement.

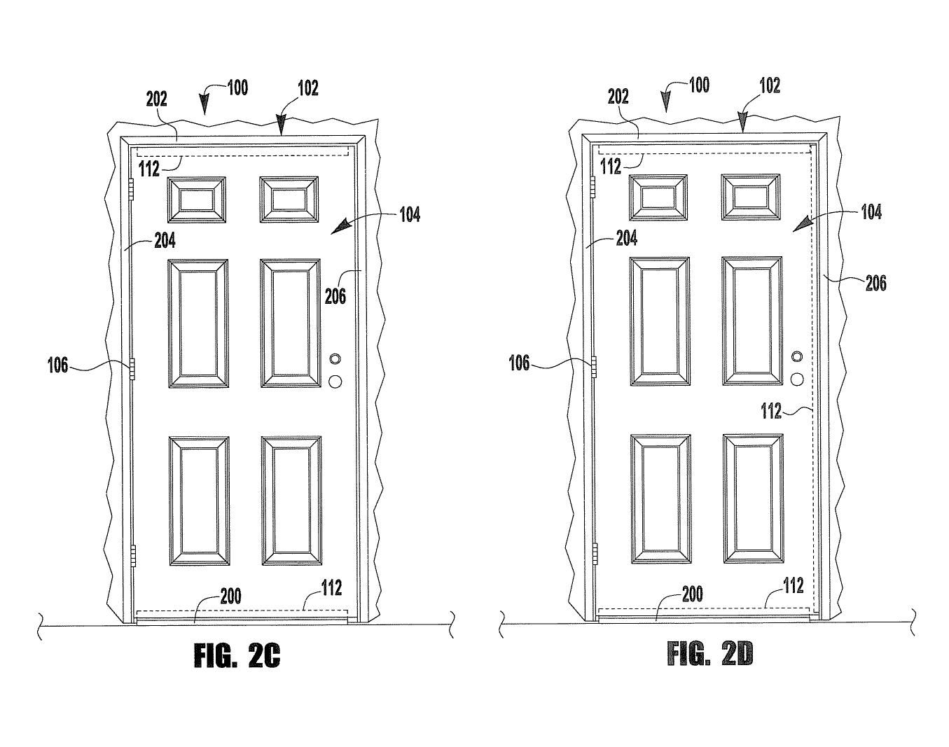

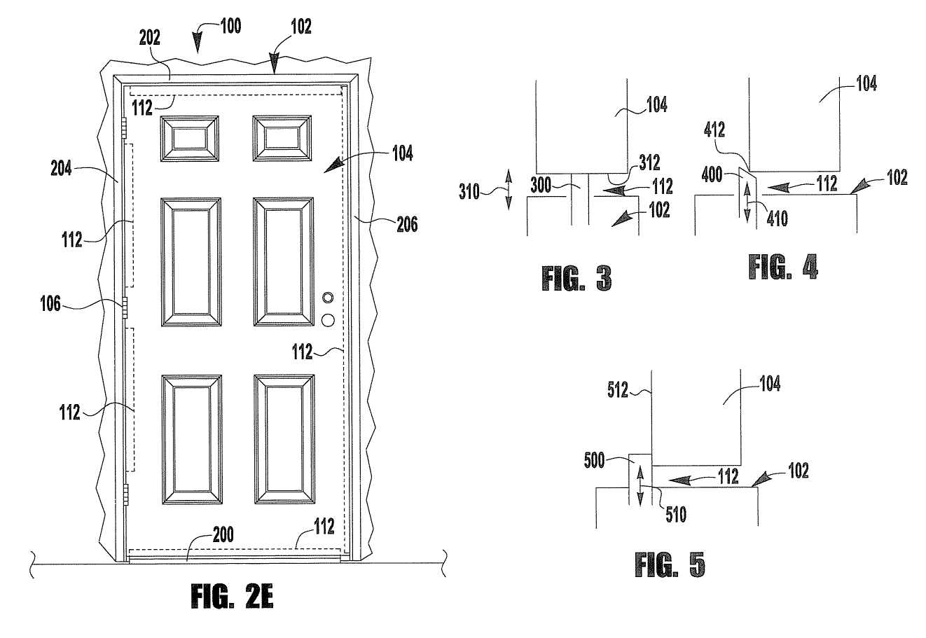

The coupling arrangement 112 may take a wide variety of different forms. The coupling arrangement 112 may be any active member associated with or connected to the door frame 102 that couples the door frame to the door when activated. FIGS. 3-11 and 20 illustrate some of the many different coupling arrangements 112 that may be employed. The coupling arrangements 112 illustrated by FIGS. 3-11 and 20 may be included on any one or more of the sill 200, the top side 202, the hinge side 204, and the latch side 206 of the door frame 102. In the FIG. 3 embodiment, the coupling arrangement 112 includes a member 300 that selectively extends and retracts from the door frame 102 as indicated by double arrow 310. When the member 300 is extended, the member presses against a side 312 of the door 102 to couple the door frame 104 to the door 102. When the member 300 is retracted, the door 102 is free to open and close. In one embodiment, the member 300 retracts completely into the frame 102.

In the FIG. 4 embodiment, the coupling arrangement 112 includes a member 400 that selectively extends and retracts from the door frame 102 as indicated by double arrow 410. When the member 400 is extended, the member presses against an edge 412 of the door 102 to couple the door frame 104 to the door 102. When the member 400 is retracted, the door 102 is free to open and close. In one embodiment, the member 400 retracts completely into the frame 102.

In the FIG. 5 embodiment, the coupling arrangement 112 includes a member 500 that selectively extends and retracts from the door frame 102 as indicated by double arrow 510. When the member 500 is extended, the member presses against or is close to a face 512 of the door 102 to couple the door frame 104 to the door 102. When the member 500 is retracted, the door 102 is free to open and close, hi one embodiment, the member 500 retracts completely into the frame 102.

In the FIG. 6 embodiment, the coupling arrangement 112 includes members 600, 602 that selectively extend and retract from the door frame 102 as indicated by double arrow 610. When the members 600, 602 are extended, the members press against edges 612, 614 of the door 102 to couple the door frame 104 to the door 102. When the members 600, 602 are retracted, the door 102 is free to open and close. In one embodiment, the members 600, 602 retract completely into the frame 102.

In the FIG. 7 embodiment, the coupling arrangement 112 includes members 700, 702 that selectively extend and retract from the door frame 102 as indicated by double arrow 710. When the members 700, 702 are extended, the members press against faces 712, 714 or are close to the faces 712, 714 of the door 102 to couple the door frame 104 to the door 102. In one embodiment, when the members 700, 702 press against the faces 712, 714 a barrier is formed between the door 104 and the frame 102 that prevents water, air, and/or light from passing between the door and the door frame. When the members 712, 714 are retracted, the door 102 is free to open and close. In one embodiment, the members 700, 702 retract completely into the frame 102.

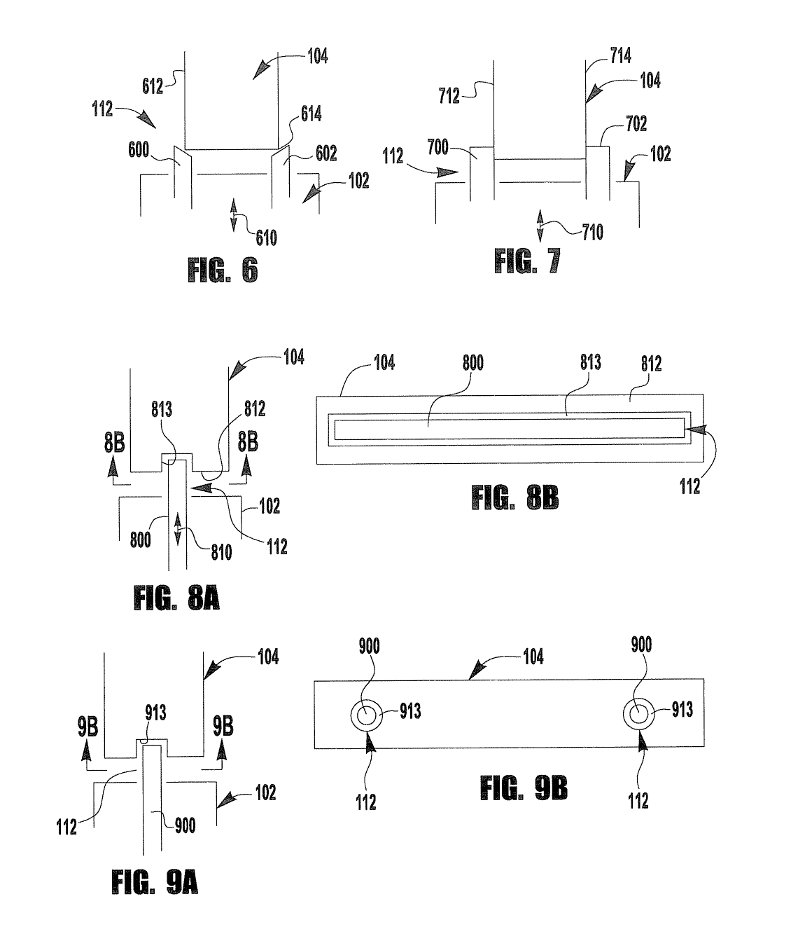

In the embodiment illustrated by FIGS. 8A and 8B, a side 812 of the door 104 includes a recess 813. The coupling arrangement 112 includes a member 800 that selectively extends and retracts from the door frame 102 as indicated by double arrow 810. When the member 800 is extended, the member extends into the recess 813 in the side 812 of the door 102 to couple the door frame 104 to the door 102. When the member 800 is retracted, the door 102 is free to open and close. In the embodiment illustrated by FIGS. 8A and 8B, the member 800 extends along substantially the entire length of the door frame side and the recess 813 extends along substantially the entire length of the door side. In one embodiment, the member 800 retracts completely into the frame 102. The coupling arrangement 112 illustrated by FIGS. 9A and 9B is similar to the arrangement illustrated by FIGS. 8A and 8B, except the elongated member 800 is replaced with pins or bolts 900. Recesses 913 are sized and shaped to accept the pins or bolts 900.

In the FIG. 10 embodiment, the coupling arrangement 112 includes a magnetic arrangement 1010 that applies a magnetic field to attract a face 1002 of the door 104. The magnetic arrangement 1010 is illustrated as forming a part of the jamb stop 1000. The magnetic field may be permanent or the magnetic field may be selectively applied. An example of a permanent magnetic arrangement 1010 is a permanent magnet weather strip applied to the door jamb stop 1000. The strength of the permanent magnet is selected such that the door is not prevented from being opened and/or the strength may be selected such that deflection of the closed door due to wind is prevented. When the magnetic arrangement 1010 does not provide a constant magnetic field, the magnetic field may be applied and removed in a wide variety of different ways. For example, the magnetic arrangement 1010 may be an electromagnet and the magnetic field is applied by selectively energizing the electromagnet. The magnetic field may also be applied and removed by selectively shielding a magnet that may be permanent or may be an electromagnet. Further, the magnetic arrangement 1010 may be controlled such that only a portion of the magnetic field is removed, such that the door is retained in the closed position by the remaining magnetic field until a user opens the door. When the magnetic field is applied, the face 1002 of the door 104 is coupled to the magnetic arrangement 1010 of the door frame 102. When the magnetic field is removed, the door 104 is free to open and close. The door may be made from metal or the door may include one or more ferrous components 1004 to allow the magnetic arrangement 1010 to attract the door. For example, a fiberglass door may include a metal strip that is attracted by the magnetic field.

In the FIG. 11 embodiment, the coupling arrangement 112 includes a magnetic arrangement 1100 that selectively applies a magnetic field to attract a side 1102 of the door 104. The side of the door may be made from metal or the door may include ferrous components 1104 to allow the magnetic arrangement 1100 to attract the door. When the magnetic field is applied, the side 1102 of the door 104 is coupled to the magnetic arrangement 1100 of the door frame 102 to inhibit movement of the door from the closed position. When the magnetic field is removed, the door 104 is free to more easily open and close.

In the FIG. 20 embodiment, the coupling arrangement 112 includes a mechanism 2010 that selectively moves the door 104 toward the door frame 102 as indicated by arrow 2012. For example, the mechanism 2010 may move the door 104 toward the sill 200 of the door frame 102. In one embodiment, the mechanism 2010 moves the door 104 into contact with the sill. The mechanism 2010 may be configured such that the door 104 closes with a spacing between the door 104 and the sill 200 and then moves the door 104 toward the sill 200 once the door is closed and the trigger 114 is activated (the trigger may be activated by closing the door or in the other manners described herein). In one embodiment, the mechanism 2010 gradually moves the door 104 toward the sill 200 as the door is moved from an open position to a closed position. The mechanism 2010 may take a wide variety of different forms. For example, the mechanism may be an electrically or pneumatically powered actuator.

The trigger 114 may take a wide variety of different forms. The trigger 114 may be any arrangement capable of causing the coupling arrangement 112 to couple the door frame 102 to the door when the door is in the closed position. Examples of triggers include, but are not limited to, electric switches, valves, mechanical linkages, etc. In one embodiment, the trigger 114 is coupled to a component of the door 104, such that the trigger is automatically activated when the door is closed, latched, and/or locked. In one embodiment, the trigger is manually activated. In one embodiment, the trigger 114 is prevented from being activated, unless the door is in the closed position.

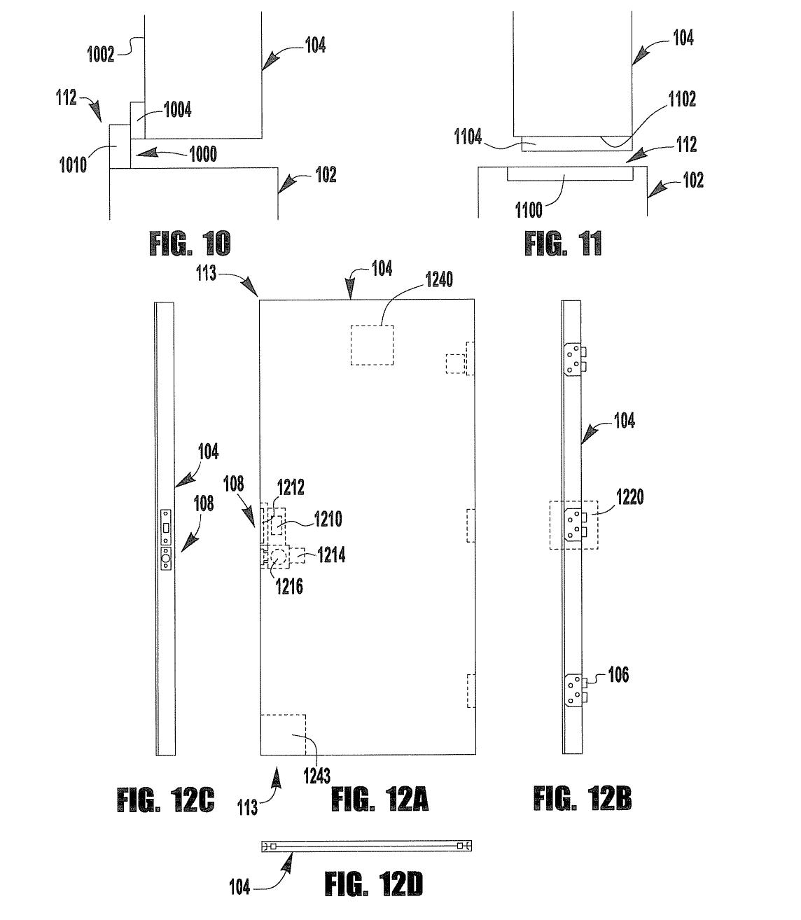

Referring to FIGS. 12 and 13, the trigger may be arranged at a variety of locations on the door frame and door assembly 100. Box 1210 represents a trigger coupled to a deadbolt 1212 of the door 104. In one embodiment, the trigger is activated when the deadbolt is set to lock the door. Box 1214 represents a trigger coupled to a door latch 1216. In one embodiment, the trigger is activated when the door is closed and the door latch 1216 latches the door 104 to the door frame 102. Referring to FIG. 13, the trigger may be disposed in the door frame. For example, the trigger may comprise a lever or swinging arm disposed in the door frame. Items 1320, 1322, 1324 represent triggers disposed on the sill 200, the top side 202, and the latch side of the door frame 102 respectively. Box 1220 represents a trigger coupled to a hinge 106 of the door. The trigger 1220 may be a proximity switch that activates the coupling arrangement 112 when the hinge is moved to a closed position. Box 1226 represents a trigger coupled to a strike 108 of the door. The trigger 1226 may be a proximity switch that activates the coupling arrangement 112 when a door latch member extends into the strike. Box 1230 represents a trigger coupled to a multi-point lock arrangement. The trigger 1230 may include multiple switches that activates the coupling arrangement 112 when all of the points of the multi-point locking arrangement are locked. Box 1236 represents an independent manually operated trigger. The trigger 1236 activates the coupling arrangement 112 when a user manually activates the trigger. The trigger 1236 may be an independent switch. The trigger 126 may be spaced apart from the door 104 and the door frame 102. Box 1240 represents a moisture sensing trigger. The moisture sensing trigger 1240 may be mounted on the door as illustrated by FIG. 12 or the moisture sensing trigger may be mounted on a structure outside the building that the door is disposed on. The moisture sensing trigger activates the coupling arrangement 112 when a predetermined amount of moisture is sensed. Box 1243 represents a deflection sensing trigger. The deflection sensing trigger 1243 activates the coupling arrangement when a predetermined amount of deflection of the door 104 is sensed while the door is in the closed position. Examples of deflection sensing triggers 1243 include, but are not limited to, a strain gauge attached to the door or a proximity sensor disposed between the door corner portion 113 (See FIG. 12A) and the door frame 102. Box 1245 (FIG. 13) represents a pressure sensing trigger. The pressure sensing trigger 1245 activates the coupling arrangement when a predetermined amount of pressure is sensed (for example pressure caused by wind). An example of a pressure sensing trigger 1245 is a weather strip that includes a pressure transducer.

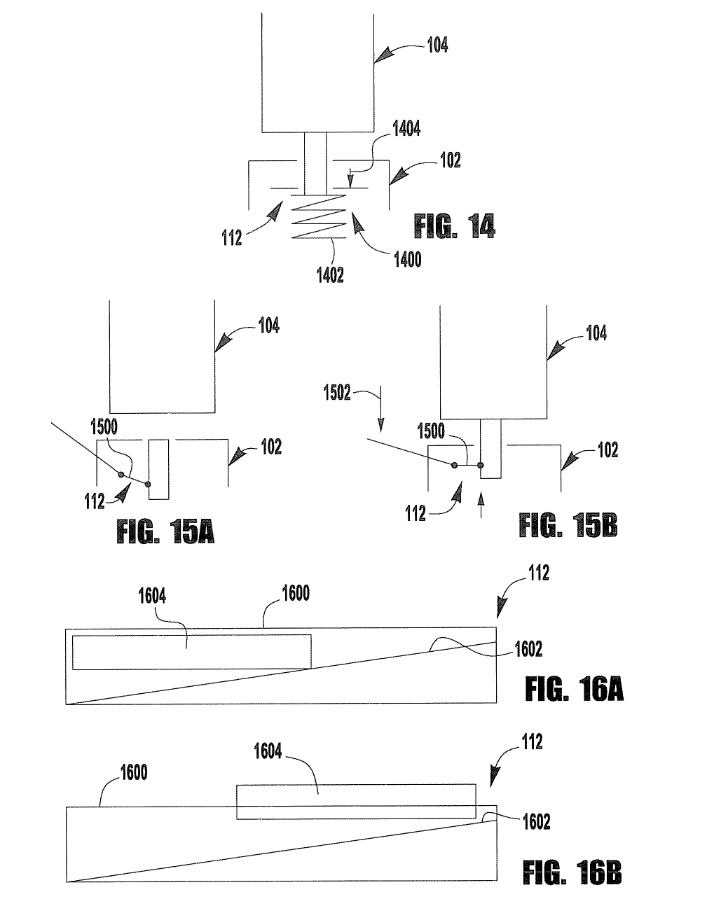

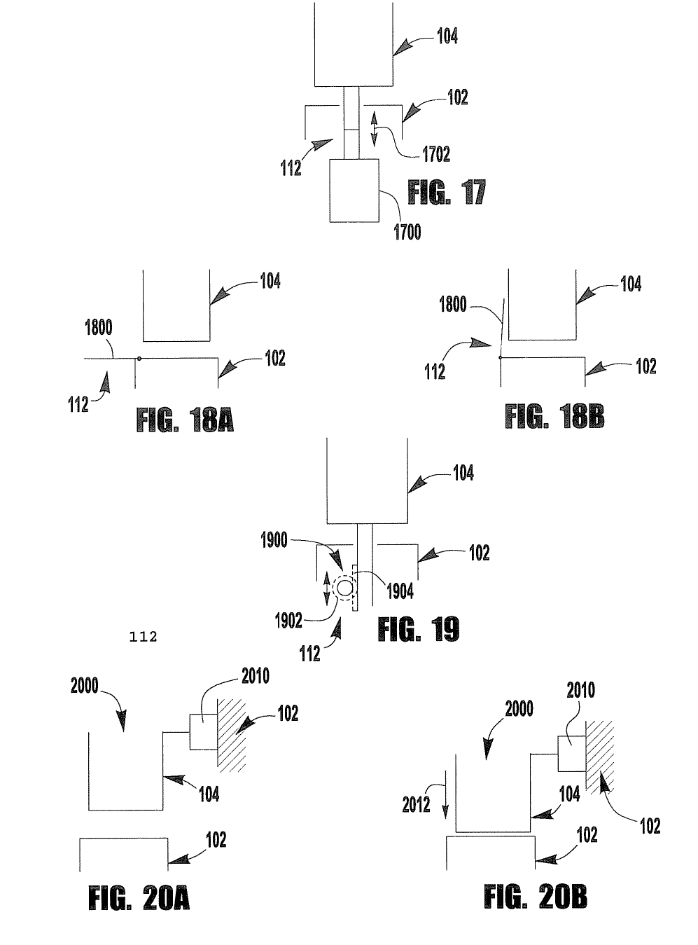

The coupling arrangement 112 may include a wide variety of different mechanisms that actuate the coupling arrangement in response to activation of the trigger. Any mechanism capable of selectively placing the coupling arrangement 112 in a coupled state and a decoupled state can be used. In the coupled state, the frame 102 is coupled to the door 104. In the decoupled state, the door 104 is free to move significantly with respect to the frame 102. For example, the door may be opened or a portion of the door may deflect away from the frame when the door is in the closed position. FIGS. 14-19 illustrate examples of a few of the many different mechanisms that can be used. FIG. 14 illustrates an actuator 1400 that includes a spring 1402 that biases the coupling arrangement 112 to the coupled state. The spring 1402 is depressed as indicated by arrow 1404 to place the coupling arrangement 112 in the decoupled state. Alternatively, the spring could be configured to bias the coupling arrangement to the decoupled state and force is applied in the opposite direction of the force applied by the spring to place the coupling arrangement in the coupled state. FIGS. 15A and 15B illustrate a lever arm 1500. The lever arm 1500 is moved in the direction indicated by arrow 1502 to place the coupling arrangement in the coupled state. The lever arm 1500 is moved in the opposite direction to place the coupling arrangement in the decoupled state. FIG. 16 schematically illustrates a coupling mechanism 1600 that includes a track or guide 1602 and a following member 1604. Movement of the following member 1604 along the track or guide 1602 from the position illustrated by FIG. 16A to the position illustrated by FIG. 16B causes the member 1604 to extend. The following member 1604 may be manually moved, or may be moved by a powered actuator. FIG. 17 illustrates a coupling arrangement 112 that includes a powered actuator 1700. The powered actuator 1700 moves the coupling arrangement between the coupled state and the decoupled state as indicated by double arrow 1702. Any powered actuator can be used. For example, the powered actuator may be a hydraulic actuator, a pneumatic actuator, or an electro-mechanical actuator. FIGS. 18A and 18B illustrate a manual coupling arrangement. The coupling arrangement 112 includes a plate 1800 that can be manually positioned on the door frame 102 between a decoupled state (FIG. 18A) and a coupled state (FIG. 18B). FIG. 19 illustrates a coupling arrangement 112 that includes a rack and pinion mechanism 1900. The rack and pinion mechanism 1900 includes a pinion 1902 that drives a rack 1904 to move the coupling arrangement between the coupled state and the decoupled state as indicated by double arrow 1902. The pillion 1902 may be rotated manually or with a motor.

Features of the door and door frame assemblies 100 described above can be used alone or in any combination. Use of the features of the door and frame assemblies allow many advantages to be realized. For example, providing an active frame that includes a coupling arrangement allows an interlock to be disposed between the door and one or more segments of the door frame along the entire length of the door frame. Such an interlock helps to reduce door deflection during testing and high wind events. As a result, higher design pressure ratings for the door system can be achieved and a deadbolt lock may be used instead of multi-lock point systems.

FIGS. 20-29 illustrate a type of door and frame assembly 2000 where, in addition to pivoting about an axis of a hinge 106 (see FIG. 1) the door 104 translates relative to the door frame 102. Referring to FIGS. 20A and 20B, such a door 104 can be moved closer to a component of the door frame 102 when the door is closed, and thereby reduce or eliminate a gap between the door and the door frame when the door is closed. The door and door frame assembly can be configured such that the door 104 moves closer to any of the sides of the door frame 102 or the door 104 moves closer to the door jamb stop 1000.

FIGS. 20A and 20B illustrate a door 104 and a sill 200 that are coupled such that the door 104 can move toward and away from the sill. In the exemplary embodiment, the door 104 moves closer to the sill 200 when the door is moved from the open position to the closed position. The door 104 can be coupled to the frame 102 in a variety of different ways that cause the door 104 to move toward the sill 200 as the door is closed.

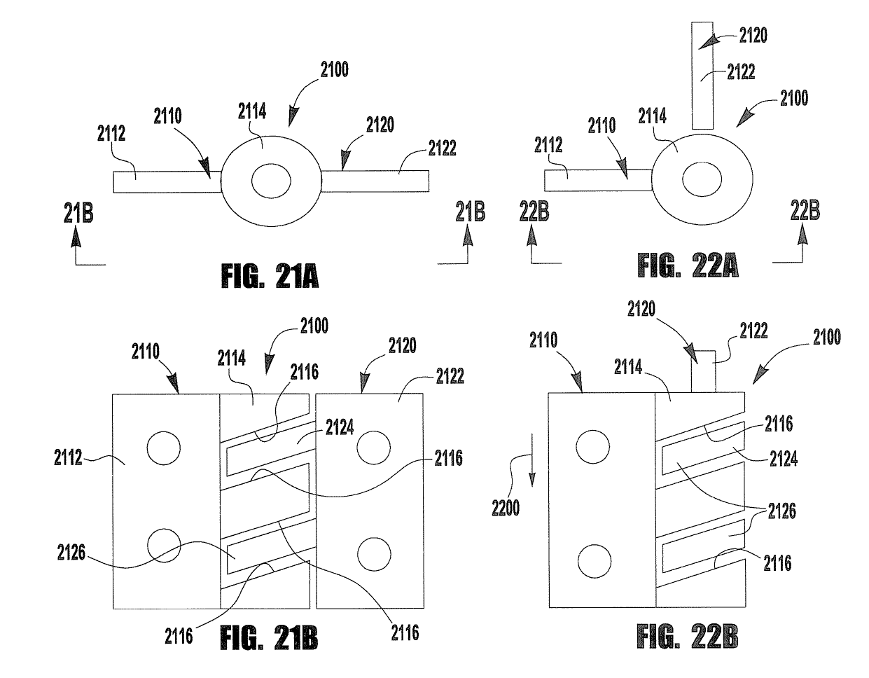

FIGS. 21 and 22 illustrate an example of a hinge 2100 configured to move a door downward, toward the sill, when the door is moved from the open position to the closed position. The hinge 2100 includes a door side member 2110 and a frame side member 2120. The door side member includes a leaf 2112 and a knuckle portion 2114. The leaf 2112 is configured for attachment with a door 104 in a well known manner. The knuckle portion 2114 defines inclined engagement surfaces 2116. The frame side member includes a leaf 2122 and a knuckle portion 2124. The leaf 2122 is configured for attachment with the door frame 102 in a well known manner. The knuckle portion 2124 defines inclined engagement rings 2126. The door side member 2110 and the hinge side member 2120 are assembled by inserting the rings 2126 between the inclined engagement surfaces 2116 and placing a pin through both. FIGS. 21A and 21B show the hinge 2100 in an open position. As the hinge 2100 is moved to a more closed position, as illustrated by FIGS. 22A and 22B, the door side leaf 2112 is moved downward with respect to the frame side leaf 2122 as indicated by arrow 2200. As a result, a door 104 connected to the frame 102 with hinge 2100 moves downward with respect to the frame 102 as the door is closed. In the exemplary embodiment, a bottom side 250 (See FIG. 2) of the door is maintained in a substantially parallel relationship with the sill as the door is moved between the open position and the closed position.

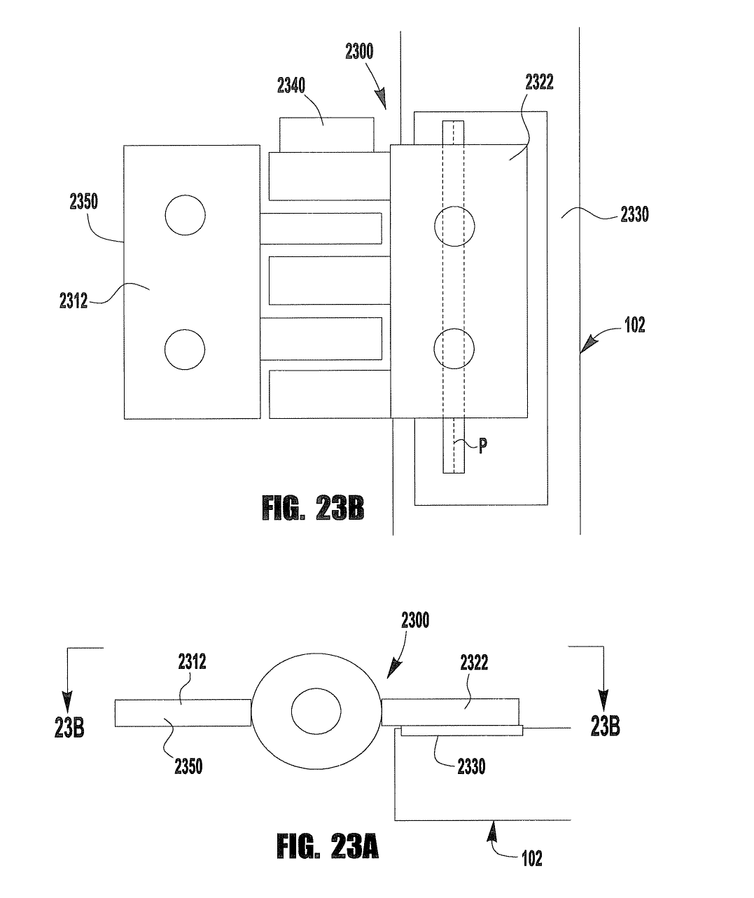

FIGS. 23 and 24 illustrate an example of a hinge mechanism 2300 configured to move a door downward, toward the sill, when the door is moved from the open position to the closed position. The hinge mechanism 2300 includes a hinge 2350, a track 2330, and a motion transfer arrangement 2340. The hinge 2350 includes a leaf 2312 that is configured for attachment with a door 104 or door a door frame 102 in a well known manner. The hinge 2350 also includes a leaf 2322 that is configured for attachment with the track 2330, such that leaf 2322 is moveable along a path of travel P defined by the track. The track may be attached to the door or to the frame. The track may take a wide variety of different forms and the path of travel P may have a wide variety of different configurations. In the example illustrated by FIG. 23A the path of travel P is generally vertical. The motion transfer arrangement 2340 is coupled to the hinge 2350. In an exemplary embodiment, the motion transfer arrangement 2340 uses relative movement of the hinge leaves 2312, 2322 to move the hinge 2350 along the track 2330. In another embodiment, the motion transfer arrangement senses the position of the hinge leaves 2312, 2322 and includes an actuator that positions the hinge along the path of travel based on the positions of the leaves. The motion transfer arrangement 2340 may take a wide variety of different forms. Examples of acceptable motion transfer arrangements 2340 include, but are not limited to, mechanical linkages, such as levers, fluid actuators, and gear trains and powered actuators that are positioned based on movement of a hinge sensor, such as a servomotor and a rotary switch. Any arrangement that causes movement of the hinge 2350 along the path of travel P as a result of relative rotational movement of the hinge leaves 2312, 2322 can be used. FIGS. 23A and 23B show the hinge 2350 in an open position. The motion transfer arrangement 2340 may be configured such that the hinge 2350 does not move relative to the frame 102 as the door closes and then moves the hinge as indicated by arrow 2400 relative to the door frame once the hinge is closed. In another embodiment, as the hinge 2350 is moved to a more closed position, as illustrated by FIGS. 24A and 24B, the hinge 2350 is gradually moved downward along the path of travel as indicated by arrow 2400. As a result, a door 104 connected to the frame 102 with hinge 2350 moves downward with respect to the frame 102 as the door is closed. In the exemplary embodiment, a bottom side 250 of the door is maintained in a substantially parallel relationship with the sill as the door is moved between the open position and the closed position.

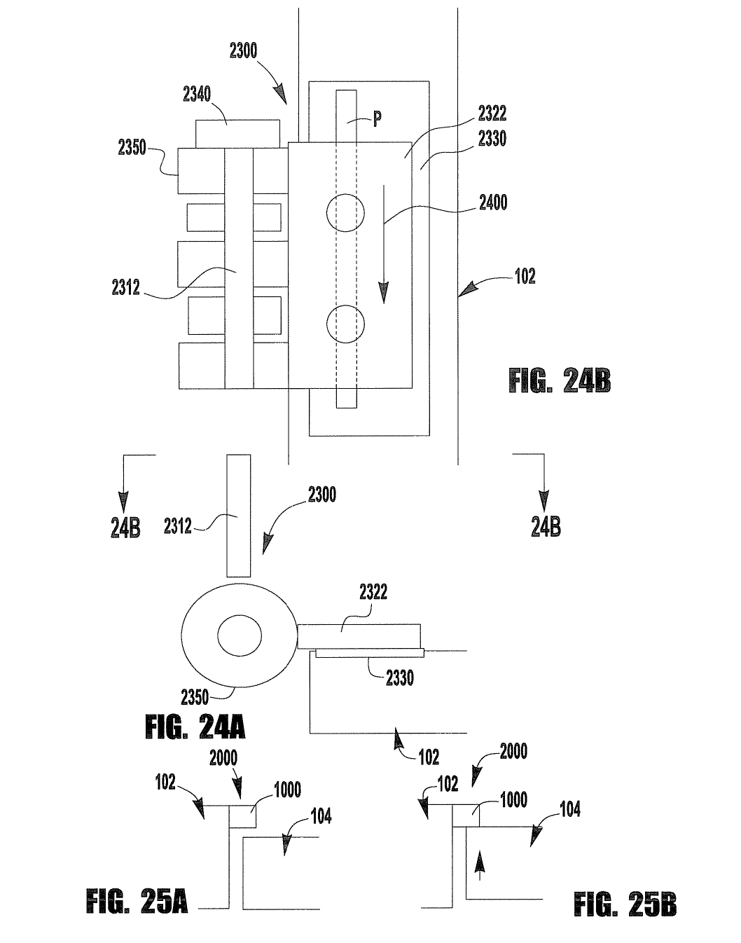

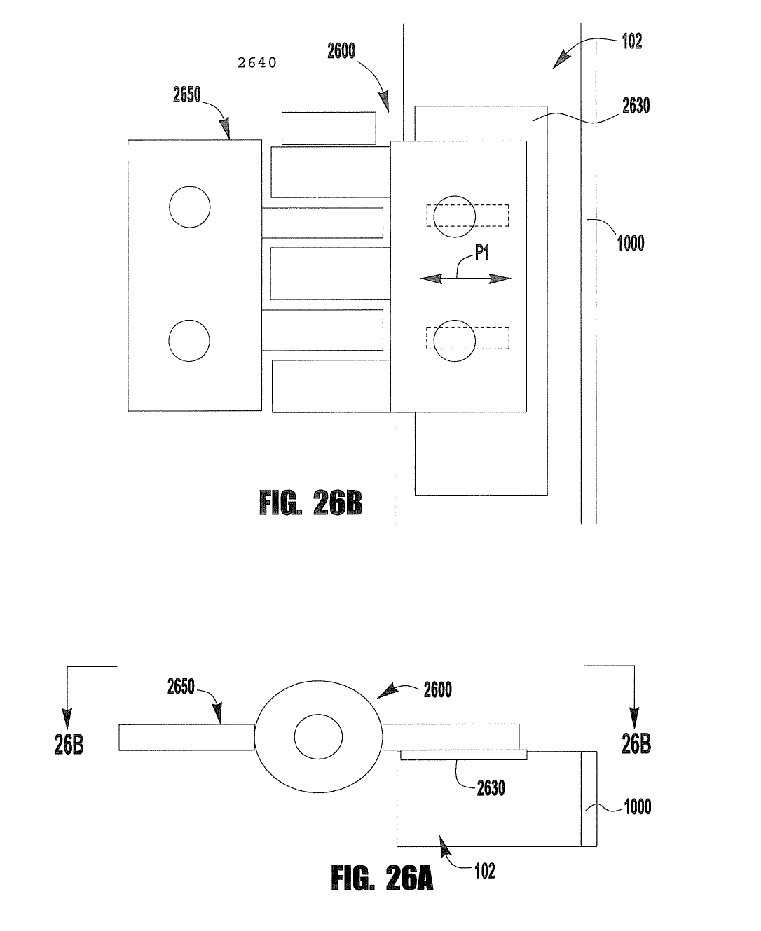

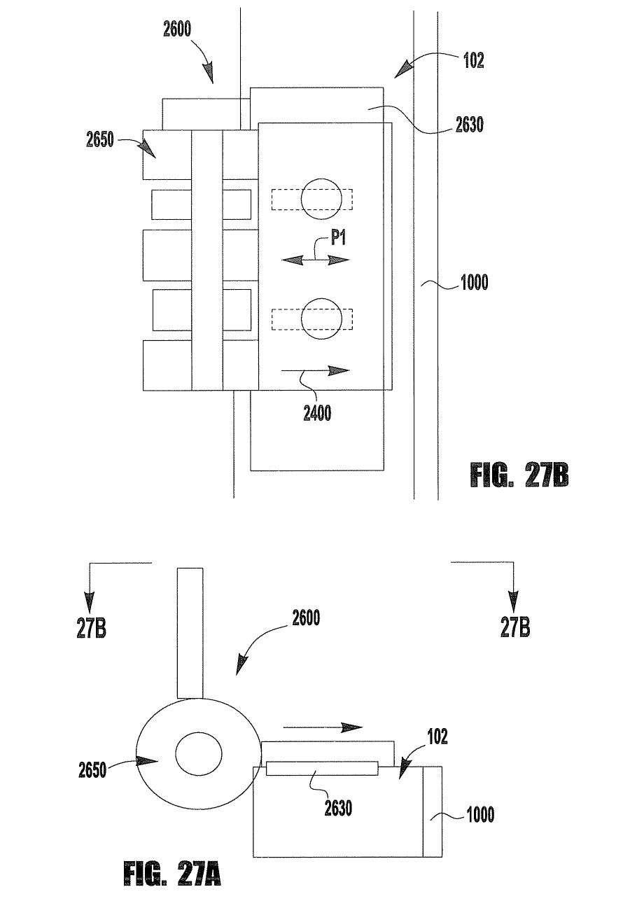

FIGS. 25A and 25B illustrate a door 104 and door frame 102 that are coupled such that the door 104 can translate toward and away from a jamb stop 1000, in addition to the rotational movement of the door about the hinge axis. In the exemplary embodiment, the door 104 translates closer to the door jamb stop when the door is moved from the open position to the closed position. The door 104 can be coupled to the frame 102 in a variety of different ways that cause the door 104 to translate toward the jamb stop 1000 as the door is closed.

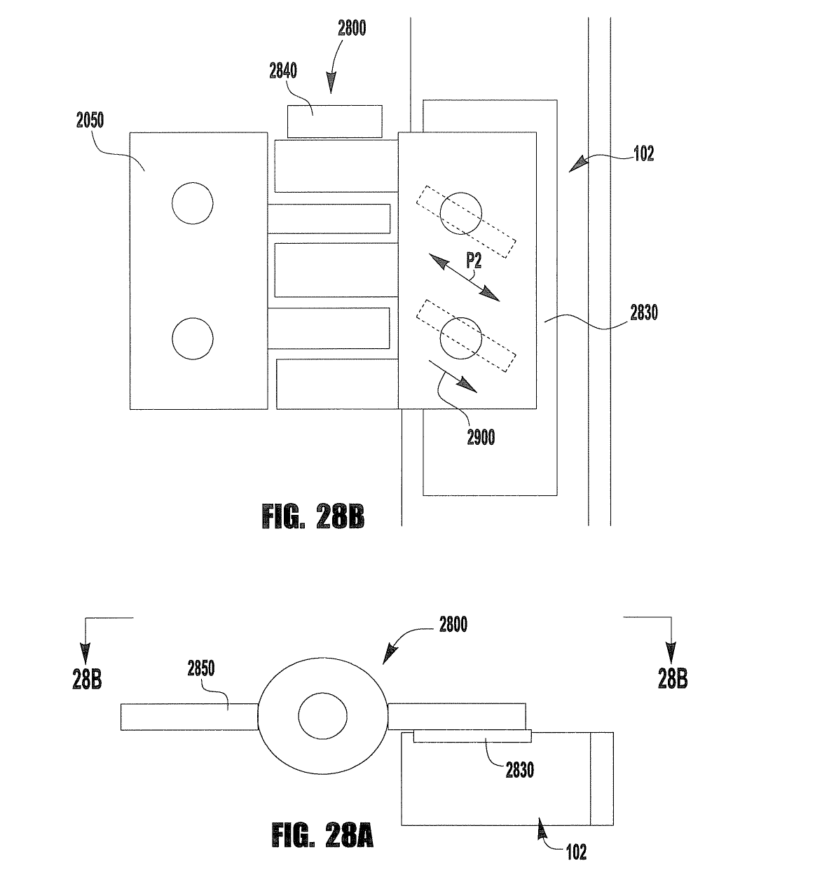

FIGS. 26 and 27 illustrate an example of a hinge mechanism 2600 configured to translate a hinge 2650 and the attached door, toward the jamb stop 1000, when the door is moved from the open position to the closed position. The hinge mechanism 2600 includes a hinge 2650, a track 2630, and a motion transfer arrangement 2640. The hinge 2650 is configured for attachment with the track 2630, such that hinge 2650 is moveable along a path of travel P₁ defined by the track. In the example illustrated by FIGS. 26A and 26B the path of travel P₁ is generally horizontal. The motion transfer arrangement 2640 is coupled to the hinge 2650. In one embodiment, the motion transfer arrangement 2640 uses rotational movement about an axis of the hinge to move the hinge 2650 along the track 2630. FIGS. 26A and 23B show the hinge 2650 in an open position. As the hinge 2650 is moved to a more closed position, as illustrated by FIGS. 27A and 27B, the hinge 2750 is moved horizontally along the path of travel as indicated by arrow 2400. As a result, a door 104 connected to the frame 102 with hinge 2650 translates toward the jamb stop 1000 as the door is closed.

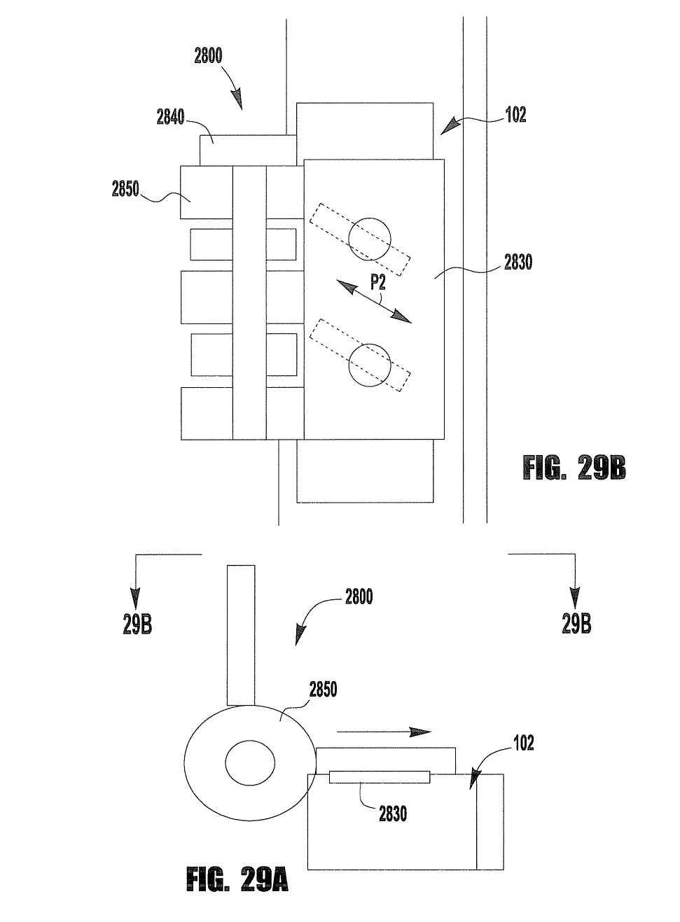

FIGS. 28 and 29 illustrate an example of a hinge mechanism 2800 configured to translate a hinge 2850 and the attached door, toward the sill and toward the jamb stop 1000, when the door is moved from the open position to the closed position. The hinge mechanism 2800 includes a hinge 2850, a track 2830, and a motion transfer arrangement 2840. The hinge 2850 is configured for attachment with the track 2830, such that hinge 2850 is moveable along a path of travel P₂ defined by the track. In the example illustrated by FIGS. 28A and 28B the path of travel P₂ is inclined. The motion transfer arrangement 2840 is coupled to the hinge 2850. In one embodiment, the motion transfer arrangement 2840 uses rotational movement about an axis of the hinge to move the hinge 2850 along the track 2830. FIGS. 28A and 28B show the hinge 2850 in an open position. As the hinge 2850 is moved to a more closed position, as illustrated by FIGS. 29A and 29B, the hinge 2850 is moved along the inclined path of travel P₂ as indicated by arrow 2900. As a result, a door 104 connected to the frame 102 with hinge 2850 translate toward jamb stop 1000 and toward the sill 200 as the door is closed.

The invention has been described with reference to the preferred embodiments. Modification and alterations will occur to others upon a reading and understanding of this specification. It is intended to include all such modifications and alterations insofar as they come within the scope of the appended claims or the equivalents thereof.

1. A door and frame assembly comprising:
a door frame including a strike and a coupling arrangement;
a door connected to the door frame, such that the door is movable between an open position and a closed position, wherein the door includes a latch that engages the strike when the door is closed;
a trigger in communication with the door frame coupling arrangement, wherein activation of the trigger causes the coupling arrangement of the door frame to couple the door frame to the door in the closed position and thereby inhibit movement of the door relative to the frame
wherein the trigger is automatically activated by closing the door.

2. (canceled)

3. (canceled)

4. (canceled)

5. The door and frame assembly of claim 1 wherein a sill of the door frame includes the coupling arrangement.

6. (canceled)

7. (canceled)

8. (canceled)

9. The door and frame assembly of claim 1 wherein a door frame trim component includes the coupling arrangement.

10. The door and frame assembly of claim 1 wherein a door frame brickmold component includes the coupling arrangement.

11. The door and frame assembly of claim 1 wherein a sill extender includes the coupling arrangement.

12. (canceled)

13. (canceled)

14. (canceled)

15. (canceled)

16. The door and frame assembly of claim 1 wherein the coupling arrangement couples the door to the door frame by attracting the door to the door frame with a magnetic field.

17. (canceled)

18. (canceled)

19. (canceled)

20. (canceled)

21. (canceled)

22. The door and frame assembly of claim 1 wherein the trigger is configured to activate when the door latches shut.

23. The door and frame assembly of claim 1 wherein trigger comprises a lever in the door frame that is activated by closing the door.

24. The door and frame assembly of claim 1 wherein trigger comprises a swinging arm in the door frame that is activated by closing the door.

25. The door and frame assembly of claim 1 wherein the trigger comprises a switch coupled to a hinge that couples the door to the door frame.

26. The door and frame assembly of claim 1 wherein trigger comprises a switch connected to a strike of the door.

27. (canceled)

28. (canceled)

29. (canceled)

30. (canceled)

31. (canceled)

32. (canceled)

33. (canceled)

34. (canceled)

35. (canceled)

36. The door and frame assembly of claim 1 wherein the coupling arrangement includes a spring that biases a member into engagement with the door to couple the door frame to the door.

37. (canceled)

38. (canceled)

39. The door and frame assembly of claim 1 wherein the coupling arrangement comprises an actuator that couples the door frame to the door when the trigger is activated.

40. The door and frame assembly of claim 39 wherein the actuator is a hydraulic actuator.

41. The door and frame assembly of claim 39 wherein the actuator is a pneumatic actuator.

42. The door and frame assembly of claim 39 wherein the actuator is an electromechanical actuator.

43. (canceled)

44. (canceled)

45. (canceled)

46. (canceled)

47. (canceled)

48. (canceled)

49. (canceled)

50. (canceled)

51. (canceled)

52. (canceled)

53. A door and frame assembly comprising:
a door frame including a strike and a coupling arrangement;
a door connected to the door frame, such that the door is movable between an open position and a closed position, wherein the door includes a latch that engages the strike when the door is closed;
a trigger in communication with the door frame coupling arrangement, wherein activation of the trigger causes the coupling arrangement of the door frame to couple the door frame to the door in the closed position and thereby inhibit movement of the door relative to the frame
wherein the trigger is a deflection sensing trigger that senses deflection of the door while the door is in a closed position and causes the coupling arrangement of the door frame to couple the door frame to the door upon a predetermined amount of deflection of the door.

54. The door and frame assembly of claim 53 wherein a sill of the door frame includes the coupling arrangement.

55. The door and frame assembly of claim 53 wherein a door frame trim component includes the coupling arrangement.

56. The door and frame assembly of claim 53 wherein a door frame brickmold component includes the coupling arrangement.

57. The door and frame assembly of claim 53 wherein a sill extender includes the coupling arrangement.

58. The door and frame assembly of claim 53 wherein the coupling arrangement couples the door to the door frame by attracting the door to the door frame with a magnetic field.

59. The door frame assembly of claim 53 wherein the trigger comprises a strain gauge coupled to the door.

60. The door frame assembly of claim 53 wherein the trigger comprises a proximity sensor disposed between a corner portion of the door and the frame.

61. The door and frame assembly of claim 1 wherein the coupling arrangement comprises an actuator that couples the door frame to the door when the trigger is activated.

62. A door and frame assembly comprising:
a door frame including a strike and a coupling arrangement;
a door connected to the door frame, such that the door is movable between an open position and a closed position, wherein the door includes a latch that engages the strike when the door is closed;
a trigger in communication with the door frame coupling arrangement, wherein activation of the trigger causes the coupling arrangement of the door frame to couple the door frame to the door in the closed position and thereby inhibit movement of the door relative to the frame
wherein the trigger is a pressure sensing trigger that senses pressure while the door is in a closed position and causes the coupling arrangement of the door frame to couple the door frame to the door upon a predetermined amount of sensed pressure.

63. The door and frame assembly of claim 62 wherein a sill of the door frame includes the coupling arrangement.

64. The door and frame assembly of claim 62 wherein a door frame trim component includes the coupling arrangement.

65. The door and frame assembly of claim 62 wherein a door frame brickmold component includes the coupling arrangement.

66. The door frame assembly of claim 62 wherein the trigger comprises a pressure sensing weather strip.

67. The door and frame assembly of claim 62 wherein the coupling arrangement comprises an actuator that couples the door frame to the door when the trigger is activated.
